(19) United States
(12) Patent Application Publication
(10) Pub. No.: US 2013/0120675 A1
(43) Pub. Date: May 16, 2013

(54) POLARIZATION ASSEMBLY AND THREE-DIMENSIONAL IMAGE DISPLAY APPARATUS HAVING THE SAME

(71) Applicants: Sejoon OH, Suwon-si (KR); Sakae Tanaka, Suwon-si (KR)

(72) Inventors: Sejoon OH, Suwon-si (KR); Sakae Tanaka, Suwon-si (KR)

(73) Assignee: SAMSUNG ELECTRONICS CO., LTD., Suwon-si (KR)

(21) Appl. No.: 13/438,208

(22) Filed: Apr. 3, 2012

(30) Foreign Application Priority Data
Nov. 16, 2011 (KR) 10-2011-0119759

(51) Int. Cl. G02F 1/1335; H01J 9/00; G02B 27/26

(52) U.S. Cl. 349/15; 359/465; 445/24

(57) ABSTRACT

A polarizing assembly includes a polarizing substrate which transmits a specific linearly-polarized light of a light incident thereto and a patterned retarder. The patterned retarder includes first retarder patterns which convert the light for a left-eye image transmitted by the polarizing substrate into a first polarized light and second retarder patterns which convert the light for a right-eye image transmitted by the polarizing substrate into a second polarized light. The first retarder patterns have a light axis substantially perpendicular to a light axis of the second retarder patterns. The polarizing substrate includes a polarizing plate which transmits the specific linearly-polarized light of the light incident thereto and a glass fiber reinforced plastic substrate which is attached to the polarizing plate.

This application claims priority to Korean Patent Application No. 10-2011-0119759 filed on Nov. 16, 2011, and all the benefits accruing therefrom under 35 U.S.C. §119, the contents of which are herein incorporated by reference in its entirety.

### BACKGROUND

1. Field of Disclosure

The invention relates to a polarization assembly and a three-dimensional (“3D”) image display apparatus. More particularly, the invention relates a polarization assembly capable of improving a display quality of a 3D image and a 3D image display apparatus having the polarization assembly.

2. Description of the Related Art

In general, a 3D image display apparatus is classified into a glass-type 3D image display apparatus and a non-glass type 3D image display apparatus. In the non-glass type 3D image display apparatus, a polarizing plate, such as a parallax barrier, a lenticular lens, etc., is disposed at a front or rear side of a display screen to separate an optical axis of the left-eye image from an optical axis of the right-eye image. The glass-type 3D image display apparatus respectively provides the left-eye image and the right-eye image to left and right eyes of an observer, which have a binocular disparity. The observer watches the left- and right-eye images through the left and right eyes, so the observer perceives the three-dimensional image.

### SUMMARY

Exemplary embodiments of the invention provide a polarization assembly capable of improving a display quality of a three-dimensional (“3D”) image.

Exemplary embodiments of the invention provide a 3D image display apparatus having the polarization assembly.

According to the exemplary embodiments, a polarizing assembly includes a polarizing substrate which transmits a specific linearly-polarized light of a light incident thereto and a patterned retarder. The patterned retarder includes first retarder patterns which convert the light for a left-eye image from the polarizing substrate into a first polarized light and second retarder patterns which convert the light for a right-eye image from the polarizing substrate into a second polarized light. The first retarder patterns have a light axis substantially perpendicular to a light axis of the second retarder patterns. The polarizing substrate includes a polarizing plate which transmits the specific linearly-polarized light of the light incident thereto, and a glass fiber reinforced plastic substrate attached to the polarizing plate.

The polarizing plate is a reflective type wire grid polarizer.

The glass fiber reinforced plastic substrate includes glass fibers disposed substantially parallel to or perpendicular to a transmission axis of the reflective type wire grid polarizer.

The glass fiber reinforced plastic substrate has a thickness equal to or smaller than about 100 micrometers.

According to the exemplary embodiments, a three-dimensional image display apparatus includes a display panel which displays an image, a polarizing substrate which transmits a specific linearly-polarized light of a light provided from the display panel, and a patterned retarder. The patterned retarder includes first retarder patterns which convert the light for a left-eye image from the polarizing substrate into a first polarized light and second retarder patterns which convert the light for a right-eye image from the polarizing substrate into a second polarized light. The first retarder patterns have a light axis substantially perpendicular to a light axis of the second retarder patterns. The polarizing substrate includes a polarizing plate which transmits the specific linearly-polarized light of the light provided from the display panel, and a glass fiber reinforced plastic substrate which is attached to the polarizing plate.

The polarizing plate is disposed between the display panel and the glass fiber reinforced plastic substrate.

The polarizing plate is a reflective type wire grid polarizer.

The glass fiber reinforced plastic substrate includes glass fibers disposed substantially parallel to or perpendicular to a transmission axis of the reflective type wire grid polarizer.

The glass fiber reinforced plastic substrate has a thickness equal to or smaller than about 100 micrometers.

The display panel includes a lower substrate, an upper substrate which is disposed facing the lower substrate and is attached to the polarizing substrate, and a liquid crystal layer disposed between the lower substrate and the upper substrate.

The lower substrate includes a soda-lime glass.

According to the above, a distance between the display panel and the patterned retarder may be reduced, and thus a cross-talk phenomenon between the left-eye image and the right-eye image may be reduced.

### BRIEF DESCRIPTION OF THE DRAWINGS

The above and other features of the invention will become readily apparent by reference to the following detailed description when considered in conjunction with the accompanying drawings wherein:

FIG. 1 is an exploded perspective view showing an exemplary embodiment of a three-dimensional (“3D”) image display apparatus according to the invention;

FIG. 2 is a cross-sectional view of the 3D image display apparatus shown in FIG. 1; and

FIG. 3 is a perspective view of an exemplary embodiment of a polarizing substrate shown in FIG. 2.

### DETAILED DESCRIPTION

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

In the glass-type three-dimensional (“3D”) image display apparatus, a patterned retarder is disposed on a display panel to change polarization properties of the light from the display panel. In order to support and guide the patterned retarder, a substrate (e.g., a glass) is used. Due to a thickness of the substrate, a cross-talk phenomenon in which the left-eye image and the right-eye image are overlapped with each other occurs when the display panel is not aligned with the patterned retarder.

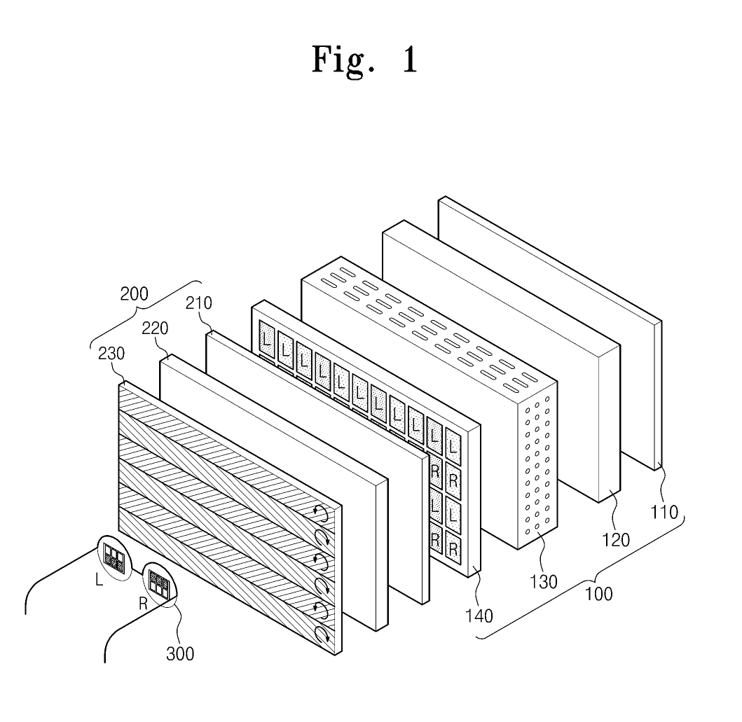

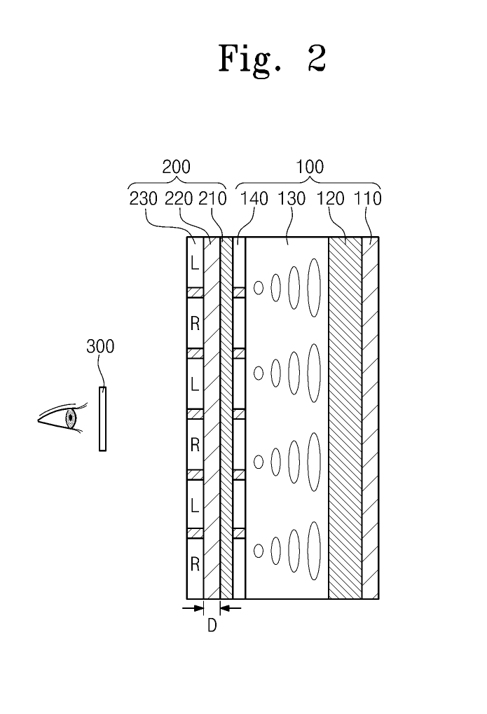

FIG. 1 is an exploded perspective view showing an exemplary embodiment of a 3D image display apparatus according to the invention and FIG. 2 is a cross-sectional view of the 3D image display apparatus shown in FIG. 1.

Referring to FIGS. 1 and 2, a 3D image display apparatus includes a display panel 100 and a polarizing substrate 200.

The display panel 100 may be various display panels, such as a liquid crystal display panel, an electrophoretic display panel, an organic light emitting display panel, a plasma display panel, etc. In the exemplary embodiment, the liquid crystal display panel 100 will be described as the display panel. The 3D image display apparatus may further include a backlight unit (not shown) disposed under the display panel 100 and at a side opposite to the viewing side of the display panel 100.

The display panel 100 has a rectangular plate shape in a plan view and displays an image through a predetermined display area thereof. The display panel 100 includes a lower polarizing plate 110, a lower substrate 120, an upper substrate 140 facing the lower substrate 120, and a liquid crystal layer 130 disposed between the lower substrate 120 and the upper substrate 140.

The lower substrate 120 includes a thin film transistor (“TFT”) array. The TFT array includes a plurality of data lines to transmit red (R), green (G), and blue (B) data voltages, a plurality of gate lines crossing the data lines to transmit gate pulses, a plurality of TFTs electrically connected to the data lines and the gate lines, a plurality of pixel electrodes to charge liquid crystal cells with the data voltages, and a plurality of storage capacitors to maintain the voltage charged in the liquid crystal cells.

In FIGS. 1 and 2, a color filter is disposed on the upper substrate 140, but it should not be limited thereto or thereby. That is, the color filter or a black matrix may be disposed on at least one of the lower substrate 120 and the upper substrate 140. A common electrode is disposed on the upper substrate 140 in the case of a vertical electric field driving method, such as a twisted nematic (“TN”) mode, a vertical alignment (“VA”) mode, etc., and the common electrode is disposed on the lower substrate 120 in the case of a horizontal electric field driving method, such as an in-plane switching (“IPS”) mode, a fringe field switching (“FFS”) mode, etc. Alignment layers (not shown) may be respectively disposed on the lower substrate 120 and the upper substrate 140 to make contact with the liquid crystal layer 130 so as to set a pre-tilt angle of liquid crystal molecules in the liquid crystal layer 130. In addition, a column spacer (not shown) may be disposed between the lower substrate 120 and the upper substrate 140 to maintain a cell gap of the liquid crystal cells.

A driver integrated circuit (“IC”) (not shown) may be disposed adjacent to a side of the lower substrate 120 in the plan view. The driver IC receives a control signal and a data signal from an external device (not shown) and applies the data voltages and the gate pulses to the TFT array to drive the display panel 100.

The lower polarizing plate 110 polarizes the light provided from the backlight unit. The liquid crystal molecules of the liquid crystal layer 130 are aligned in a predetermined direction according to the voltages applied to the pixel electrode and the common electrode to control a transmittance of the light provided by the backlight unit and through the lower polarizing plate 110, thereby displaying a desired image.

In the above-mentioned display panel 100, a left-eye image L and a right-eye image R are alternately displayed in a line-by-line manner.

The polarizing substrate 200 includes a polarizing plate 210, a glass fiber reinforced plastic substrate 220 and a patterned retarder 230.

The polarizing plate 210 is disposed on the upper substrate 140 of the display panel 100 to transmit a linearly-polarized light of the light incident thereto through the liquid crystal layer 130 of the display panel 100.

The glass fiber reinforced plastic substrate 220 may be integral with the polarizing plate 210 to support the polarizing plate 210. The polarizing plate 210 is integral with the glass fiber reinforced plastic substrate 220 to form the polarizing substrate 200. In this case, the polarizing plate 210 is attached to the glass fiber reinforced plastic substrate 220 to in turn attach the glass fiber reinforced plastic substrate 220 to the display panel 100. In other words, the polarizing plate 210 is disposed between the display panel 100 and the glass fiber reinforced plastic substrate 220, which is otherwise referred to as an “in-cell polarizing plate.”

The patterned retarder 230 includes a first retarder pattern and a second retarder pattern, which are alternately arranged with each other, as illustrated by the striped-pattern in FIG. 1 and the alternating. The first and second retarder patterns are alternately arranged to be inclined at angles of about +45 degrees and about −45 degrees with respect to a transmission axis of the polarizing plate 210, respectively. Each of the first and second retarder patterns delays a phase of the light by about λ/4 using a birefringence medium. The first retarder pattern has a light axis substantially perpendicular to a light axis of the second retarder pattern. Thus, the first retarder pattern is disposed to face the line of the display panel 100, in which the left-eye image is displayed, to convert the light for the left-eye image into a first polarized light (a circularly-polarized light or a linearly-polarized light). The second retarder pattern is disposed to face the line of the display panel 100, in which the right-eye image is displayed, to convert the light for the right-eye image into a second polarized light (a circularly-polarized light or a linearly-polarized light). In one exemplary embodiment, for instance, the first retarder pattern may be a polarizing filter to transmit the left-circularly polarized light and the second retarder pattern may be a polarizing filter to transmit the right-circularly polarized light.

Polarizing glasses 300 includes a polarizing film disposed on a left-eye glass thereof to transmit the first polarized light and a polarizing film disposed on a right-eye glass thereof to transmit the second polarized light. Accordingly, the observer wearing the polarizing glasses 300 watches the left-eye image through the left eye and the right-eye image through the right eye, so the observer perceives the 3D image displayed on the display panel 100.

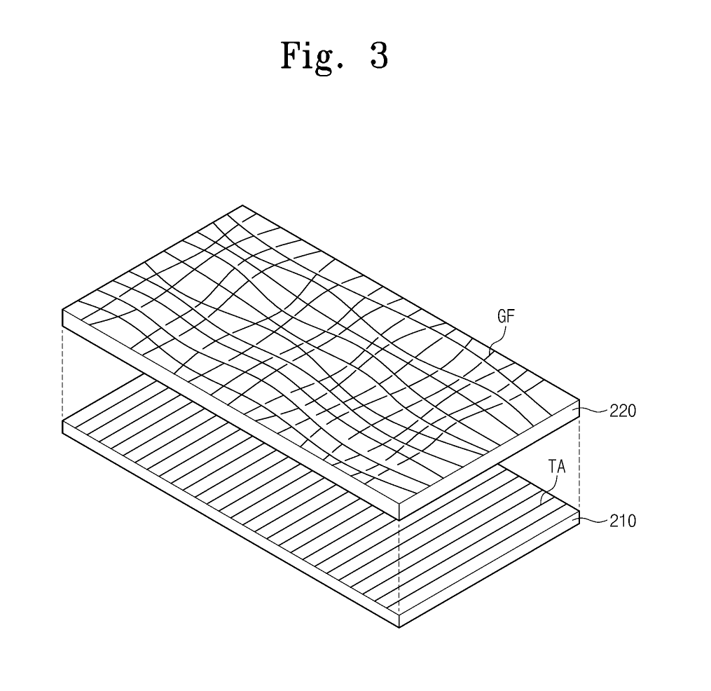

FIG. 3 is a perspective view of an exemplary embodiment of a polarizing substrate shown in FIG. 2.

Referring to FIG. 3, the glass fiber reinforced plastic substrate 220 includes a glass fiber and a plastic. The glass fiber reinforced plastic substrate 220 may include one of various glass fibers, such as a short staple fiber, a long staple fiber, a textile, etc. Longitudinal axes of the glass fibers GF of the glass fiber reinforced plastic substrate 220 are disposed to be substantially parallel with and/or perpendicular to the transmission axis TA, and thus the transmittance of the polarizing plate 210 may be improved. As a result, a contrast ratio of the display panel 100 may be improved. In an exemplary embodiment, the polarizing plate 210 may be a reflective type wire-grid polarizer.

Referring to FIG. 2 again, the glass fiber reinforced plastic substrate 220 has a thickness D of about 100 micrometers in a direction taken perpendicular to the plan view. When the glass fiber reinforced plastic substrate 220 is used as a substrate to support the polarizing plate 210, a distance between the patterned retarder 230 and the display panel 100 is reduced. Thus, a cross-talk phenomenon between the left-eye image and the right-eye image may be reduced and a viewing angle of the display panel 100 may be improved.

In addition, the glass fiber reinforced plastic substrate 220 has a thermal expansion coefficient of about 80×10⁻⁷/° C. The lower substrate 120 of the display panel 100 may be a soda-lime glass substrate to coordinate the thermal expansion coefficient between the glass fiber reinforced plastic substrate 220 and the display panel 100. The soda-lime glass has the thermal expansion coefficient of about 80×10⁻⁷/° C.

Hereinafter, a process in which the observer perceives the 3D image through the 3D image display apparatus will be described.

The display panel 100 receives the light from the backlight unit (not shown) and separates the left-eye image and the right-eye image from each other to display the left-eye image and the right-eye image, such as illustrated in FIG. 1. The light passing through the display panel 100 is incident into the polarizing plate 210. The polarizing plate 210 transmits the light substantially parallel with the transmission axis thereof. The first retarder pattern of the patterned retarder 230 disposed to face the line in which the left-eye image is displayed on the display panel 100 polarizes the light for the left-eye image, and the second retarder pattern of the patterned retarder 230 disposed to face the line in which the right-eye image is displayed on the display panel 100 polarizes the light for the right-eye image, such as illustrated in FIG. 2. Thus, the observer wearing the polarizing glasses 300 watches only the left-eye image through the left eye and only the right-eye image through the right eye, thereby perceiving the 3D image displayed on the display panel 100.

In this case, as the distance between the display panel 100 and the patterned retarder 230 decreases, the cross-talk phenomenon in which the left-eye image and the right-eye image are overlapped may be reduced. To this end, the polarizing plate 210 is integral with the glass fiber reinforced plastic substrate 220, and thus the distance between the display panel 100 and the patterned retarder 230 may be minimized.

When a resolution of the display panel 100 is increased, the resolution of the 3D image is increased. In general, a full high definition (“FHD”) two-dimensional (“2D”) image has a resolution of 1920×1080 or 3040×1080. Although an FHD 3D image is realized by using a 2D image display panel 100 having a resolution of 1920×2160 or more, a vertical cross-talk may be reduced since the polarizing plate 210 is integral with the glass fiber reinforced plastic substrate 220. Thus, the resolution and the display quality of the 3D image may be improved.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A polarizing assembly comprising:
a polarizing substrate which transmits a specific linearly-polarized light of a light incident thereto; and
a patterned retarder including first retarder patterns which convert the light for a left-eye image transmitted by the polarizing substrate into a first polarized light, and second retarder patterns which convert the light for a right-eye image transmitted by the polarizing substrate into a second polarized light, the first retarder patterns having a light axis substantially perpendicular to a light axis of the second retarder patterns,
wherein the polarizing substrate comprises:
a polarizing plate which transmits the specific linearly-polarized light of the light incident thereto; and
a glass fiber reinforced plastic substrate which is attached to the polarizing plate, and between the polarizing plate and the patterned retarder.

2. The polarizing assembly of claim 1, wherein the polarizing plate is a reflective type wire grid polarizer.

3. The polarizing assembly of claim 2, wherein the glass fiber reinforced plastic substrate comprises glass fibers substantially parallel to or perpendicular to a transmission axis of the reflective type wire grid polarizer.

4. The polarizing assembly of claim 1, wherein the glass fiber reinforced plastic substrate has a thickness equal to or smaller than about 100 micrometers.

5. A three-dimensional image display apparatus comprising:
a display panel which displays an image;
a polarizing substrate which transmits a specific linearly-polarized light of a light provided from the display panel; and
a patterned retarder including first retarder patterns which convert the light for a left-eye image transmitted by the polarizing substrate into a first polarized light, and second retarder patterns which convert the light for a right-eye image transmitted by the polarizing substrate into a second polarized light, the first retarder patterns having a light axis substantially perpendicular to a light axis of the second retarder patterns,
wherein the polarizing substrate is between the display panel and the patterned retarder, and comprises:
a polarizing plate which transmits the specific linearly-polarized light of the light provided from the display panel; and
a glass fiber reinforced plastic substrate which is attached to the polarizing plate.

6. The three-dimensional image display apparatus of claim 5, wherein the polarizing plate is between the display panel and the glass fiber reinforced plastic substrate.

7. The three-dimensional image display apparatus of claim 6, wherein the polarizing plate is a reflective type wire grid polarizer.

8. The three-dimensional image display apparatus of claim 7, wherein the glass fiber reinforced plastic substrate comprises glass fibers substantially parallel to or perpendicular to a transmission axis of the reflective type wire grid polarizer.

9. The three-dimensional image display apparatus of claim 5, wherein the glass fiber reinforced plastic substrate has a thickness equal to or smaller than about 100 micrometers.

10. The three-dimensional image display apparatus of claim 5, wherein the display panel comprises:
a lower substrate;
an upper substrate which faces the lower substrate and is attached to the polarizing substrate; and
a liquid crystal layer between the lower substrate and the upper substrate.

11. The three-dimensional image display apparatus of claim 10, wherein the lower substrate comprises a soda-lime glass.

12. A method of forming a three-dimensional image display apparatus, the method comprising:
disposing a polarizing substrate on a viewing side of a display panel, wherein the polarizing substrate transmits a specific linearly-polarized light of a light provided from the display panel; and
disposing a patterned retarder on a viewing side of the polarizing substrate,
wherein
the patterned retarder includes first retarder patterns which convert the light for a left-eye image transmitted by the polarizing substrate into a first polarized light, and second retarder patterns which convert the light for a right-eye image transmitted by the polarizing substrate into a second polarized light, the first retarder patterns having a light axis substantially perpendicular to a light axis of the second retarder patterns, and
the polarizing substrate is between the display panel and the patterned retarder, and comprises:
a polarizing plate which transmits the specific linearly-polarized light of the light provided from the display panel; and
a glass fiber reinforced plastic substrate which is attached to the polarizing plate.

13. The method of claim 12, wherein the polarizing plate is between the display panel and the glass fiber reinforced plastic substrate.

14. The method of claim 13, wherein the glass fiber reinforced plastic substrate comprises glass fibers which have longitudinal axes substantially parallel to or perpendicular to a transmission axis of the polarizing plate.

15. The method of claim 12, wherein the glass fiber reinforced plastic substrate has a thickness equal to or smaller than about 100 micrometers.
